(19) United States
(12) Patent Application Publication
(10) Pub. No.: US 2011/0083473 A1
(43) Pub. Date: Apr. 14, 2011

(54) GRAVITY BENDING OVEN AND GRAVITY BENDING METHOD FOR GLASS

(76) Inventors: Axel Engels, Romhild (DE); Gerd Hänisch, Romhild (DE)

(21) Appl. No.: 10/584,910

(22) PCT Filed: Dec. 23, 2004
(86) PCT No.: PCT/EP04/14666

§ 371 Date: Jul. 5, 2007

(30) Foreign Application Priority Data
Dec. 29, 2003 (DE) 103 61 756.6

(51) Int. Cl. C03B 23/025; C03B 5/42

(52) U.S. Cl. 65/107; 65/273

(57) ABSTRACT

The invention relates to a gravity bending oven for glass panes, provided with several heating groups (5) (16) which are arranged in a cistern-shaped oven lower part (1) and a cover-shaped oven upper-part (2), and heat insulation (8) arranged on the inside of the oven walls (7). According to the invention, a plurality of channels (9) are arranged in the heat insulation, said channels being cross-flown by a heat transfer medium and are used to guide heat away from the heat insulation. The invention also relates to a gravity bending method for glass panes, which can be carried out, preferably, using said type of oven.

The present invention relates to a gravity bending oven for glass panes, having a plurality of heating groups in the cover-shaped oven upper part and in the tub-shaped oven lower part, and having a heat insulation on the inside of the oven walls. The invention also relates to a method for gravity bending of glass panes using said type of oven.

From EP 0 317 409 B1, a device for thermal bending of glass panes by gravity is known, which uses an oven having at least one preheating and one bending station. A movable carriage that supports the glass, transports the panes in the oven from one station to the next. Adjoining the bending station may be a blowing station and one or more cooling stations. Heating of the glass pane takes place by means of resistance heating elements, which are arranged on the inner walls of the oven and whose temperature is held constant. The heat capacity of the oven walls is limited to a value below the heat capacity of the movable carriage and of the glass pane. In the cooling station the glass is brought to a temperature at which it can be manipulated further. As a result of the necessary transportation of the glass panes between the individual stations there exists the risk of damage due to vibrations, which can result in undesirable material stresses as well. Moreover, the heat-resisting construction of the transport system is complex, expensive, and prone to malfunction.

DE 690 20 481 T2 shows a device for bending and annealing of glass panes using an oven for heating the glass sheet, and conveyor means in the oven for moving the glass sheet through the oven. The conveyor means have longitudinal rows of oven mini-rollers to carry the glass sheet, their position being changeable in order to attain the contour of a desired curvature. For cooling, air is blown directly onto the glass pane. In the case of large-surface panes in particular, this leads to material stresses, which can quickly result in breakage.

The device for bending of glass panes described in WO 01/23310 A1 uses a heating furnace equipped with a first group of heating-elements on the inner wall surface of the furnace, and a second group of heating elements fixed independently from the inner wall surface of the furnace. The distance of the heating elements of the second group from the glass pane can be varied individually for each heating element. By selectively using the heating elements of the second group, the glass pane can be heated locally, and in doing so, a predefined temperature distribution can be attained in the glass pane. The glass pane is situated on a bending mold, which is transported through the oven. Adjusting the individual heating elements, however, is technologically complex and disadvantageous especially in the case of varying bending jobs. The bending process is followed by a slow, but accordingly also very time-consuming, cooling of the glass pane in the cooling area.

EP 1 241 143 A2 describes an annealing oven that is equipped both at the bottom, as well as in the upper oven region with heating elements, as well as with elements for heat convection. The glass panes are transported through the oven via rollers, which results in undesirable mechanical stresses for the glass. The heat convection elements that are disposed in the longitudinal direction create different heat convection zones that can be altered relative to each other. To heat the glass pane, convection air is directly blown onto the glass pane from above and below. The flows that are created in the process, however, cause an uneven heating especially in large glass panes, which, just like the relatively uneven flow during the cooling process, can lead to considerable material stresses.

In order to prevent the cracking of a glass pane, which is particularly prone to breakage especially during the cooling process, the heating process and cooling process must proceed very evenly. It is true that it is known, from the above-cited prior art, to divide gravity bending ovens into multiple zones for preheating, bending, and cooling. The glass material is guided through these zones via a transport means. In the transition regions between the individual zones, however, spontaneous temperature fluctuations occur. Particularly when relatively large glass panes are processed, problems occur while passing through these zone transitions, as certain areas of the glass pane are still located in the bending zone, while other areas of the glass pane are already being cooled. The uneven temperature distribution in the glass pane results in undesirable material stresses and, hence, oftentimes in glass breakage.

To attain technologically desirable short cooling times, conventional gravity bending ovens implement the cooling of the heated glass panes by directly blowing cool air onto the glass panes. Especially in the case of large glass panes, achieving an even cooling in this manner is problematic. The temperature fluctuations that unavoidably occur in the process, in turn, lead to harmful material stresses, which can lead to the destruction of the glass pane.

It is therefore the object of the present invention to make available a gravity bending oven for glass, wherein a rapid cooling does not need to be implemented by directly blowing cool air onto the glass panes, and which permits, especially in the case of large glass-pane dimensions, a gentle and even cooling while maintaining or staying below previous cooling times. Additionally, a method for gravity bending of glass panes shall be provided that can be carried out in such a gravity bending oven.

These and other objects are met with the inventive gravity bending oven, which has arranged in the heat insulation a multitude of channels which, in order to carry heat away from the heat insulation (hereinafter also referred to simply as “insulation”), have a heat transport medium flowing through them.

The inventive gravity bending oven implements a gentle and very even cooling of the bent or shaped panes through indirect cooling of the system, from which the process heat is withdrawn uniformly via a heat transport medium. The heated glass material releases its heat to the oven walls and to the insulation layers that are installed there, both directly through heat radiation and indirectly through heat exchange with the air that is present in the oven. Because this heat is channeled directly out of the insulation, it is no longer necessary to blow fresh air directly onto the glass pane to shorten the cooling times. A cooling process of this type prevents disruptive air movements caused by entering fresh air. A static atmosphere is created in the oven chamber. In this manner it is also possible to process oversized glass panes and/or glass panes up to thicknesses of approximately 20 mm, whose cooling is particularly problematic. An additional advantage of this novel cooling is that the elimination of direct air cooling makes it possible to prevent the glass from being contaminated by particles that are inevitably contained in the air.

The inventive gravity bending oven does without a subdivision of the oven into various zones for the preheating, bending and cooling. For this reason it is no longer necessary to transport glass panes through the oven, since the entire oven interior is brought to the parameters necessary for carrying out the individual process steps. This means that nearly the entire oven interior is available for the processing even of very large glass panes, which heretofore could not be shaped at all by gravity bending.

According to an advantageous embodiment, the oven interior has a height greater than 800 mm, a width greater than 2000 mm, and a depth greater than 2000 mm. Particularly advantageous is an oven interior having a height of approximately 1050 mm, a width of approximately 3470 mm, and a depth of approximately 6000 mm. An oven of this type is also suitable for oversized glass panes having a width of approximately 3000 mm and a depth of approximately 6000 mm. Because of the large dimensions of the oven it is also possible, however, to process many smaller panes simultaneously, making it possible to shape large piece numbers under the same processing conditions.

According to a preferred embodiment, the heating groups in the oven upper part and in the oven lower part can be controlled independently from each other. A subdivision of the heating capacity into seven heating groups in the oven upper part and four heating groups in the oven lower part has proven particularly advantageous. This creates eleven individually controllable heating zones that permit a very exact temperature setting at the glass. As a result of this highly precise temperature control a localized overheating can be prevented.

It has proven advantageous if the oven upper part is liftable by means of a spindle lifting means and can thereby be kept absolutely horizontal. In the lifted-off position of the oven upper part, the oven lower part can be rolled out from underneath the cover range of the oven upper part, in such a way that the entire opening width of the oven lower part is accessible. As a result of this movability of the oven lower part, handling during loading and removal can be significantly improved.

In a modified embodiment, a plurality of oven lower parts and a plurality of additional cooling stations for the residual cooling of the bent glass panes are used, which are either open or closed by a common oven upper part, depending on the processing stage. The oven upper part can thus be used even more efficiently, resulting in an increase in the processing capacity at reduced machine costs.

One advantageous embodiment utilizes medium-wave quartz radiators as heating groups in the oven upper part and resistance heating elements as heating groups in the oven lower part. The quartz radiators should preferably have a particularly long length of approximately 3600 mm. Due to the horizontal position of the oven upper part and its evenly implemented lifting on all sides by means of a spindle lift, the sensitive quartz radiators can be supported without lateral guiding means. As a result of the feasible elimination of a lateral guiding means, the occurrence of material stresses in the quartz material can be significantly reduced and the risk of damage to the quartz radiators can thus be prevented. The quartz radiators may be fastened to the oven upper part by means of silicon carbide elements, which are usable at temperatures up to 1300° C.

In an additional advantageous embodiment, the oven floor has disposed on it above the insulation a non-conducting heating receptacle with very high load-bearing capacity, for example in the form of a grid. This grid is dimensioned such that it can carry the large masses of the bending molds and glass panes. The oven floor region above the grid is divided into a multitude of removable floor segments. To accommodate bending molds, individual oven floor segments are removed and bending molds are positioned in their place. With the aid of this subdivision into oven floor segments the position of the bending molds can be fixed reproducibly.

Additionally it is advantageous to arrange a multitude of air inlet openings in the oven floor below the heating elements positioned there, and a plurality of outgoing-air openings in the oven upper part. Depending on the requirements, these openings are adjustable from a fully closed position all the way to a fully opened position. As a result of the inflow of incoming air and simultaneous carrying off of outgoing air, a controlled circulating air movement is created inside the oven. This circulating air movement provides for an even temperature distribution, for example during the preheating or bending process. It is particularly advantageous if the volume of outgoing air is adjustable via a fan. The incoming air is forced past the heating elements, where it is heated in a targeted manner. This prevents cold fresh air from hitting the heated glass pane.

Incoming-air openings having a diameter of approximately 40 mm and outgoing-air openings having a diameter of approximately 80 mm have proven particularly advantageous. In the case of the above-described embodiment of a glass bending oven for oversized glass panes, using approximately 63 incoming-air openings and approximately four outgoing-air openings is particularly advantageous.

Also provided in accordance with the invention, to meet the above-stated object, is a method for gravity bending of glass panes in a gravity bending oven whose insides of the oven walls are provided with a heat insulation, in which the heat that is released to the insulation during the cooling process is channeled off via a heat transport medium that flows through a multitude of channels arranged in the insulation.

Additional advantages, details and further developments of the invention will become apparent from the following description of preferred embodiments, with reference to the drawing, in which:

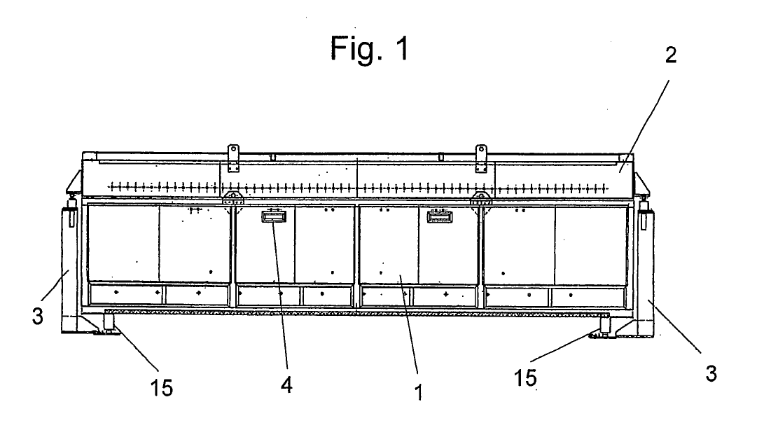

FIG. 1 shows a side view of an inventive gravity bending oven;

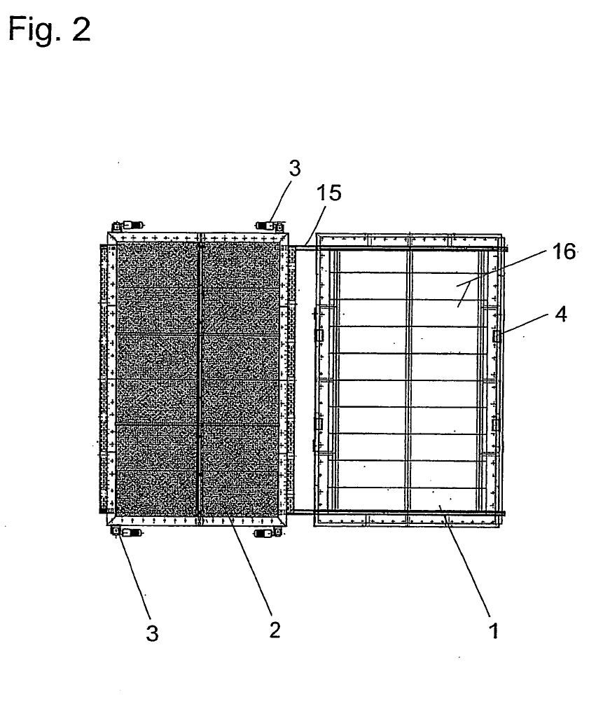

FIG. 2 shows a view of the gravity bending oven from above with the oven lower part rolled out to the side;

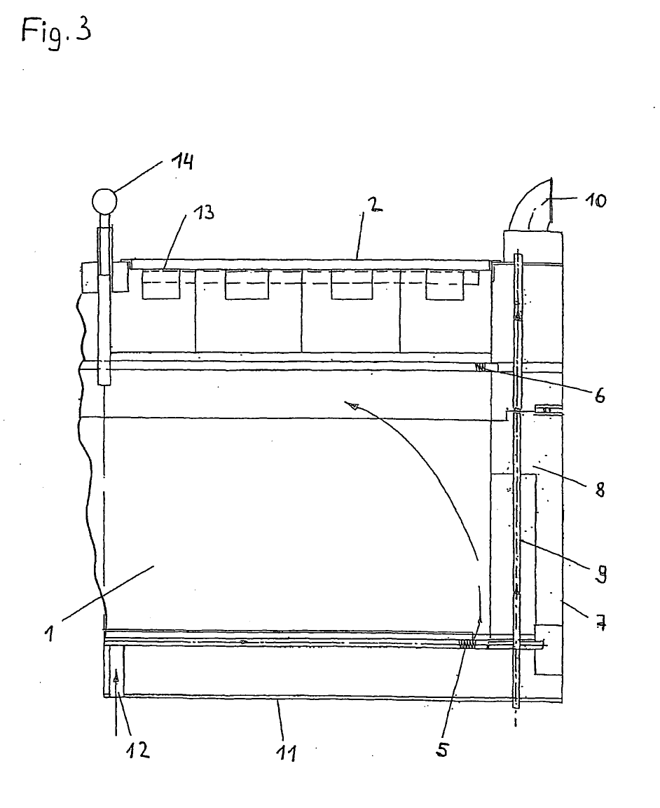

FIG. 3 shows a detail illustration of the gravity bending oven in a longitudinal section;

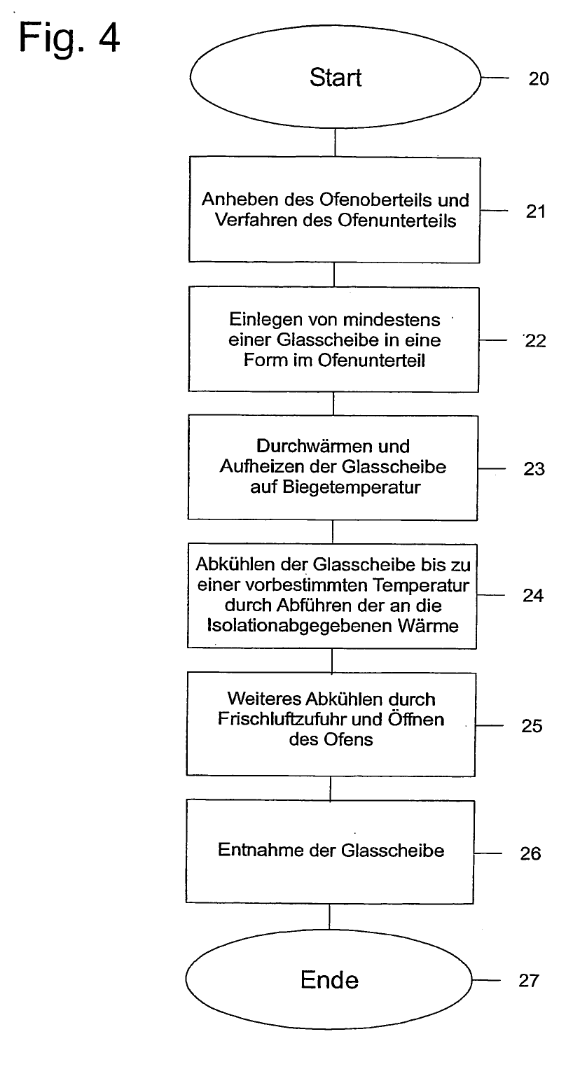

FIG. 4 shows a flow chart of an inventive process for gravity bending of glass panes.

FIG. 1 shows a side view of a first embodiment of an inventive gravity bending oven. The oven comprises a tub-shaped oven lower part 1 and a cover-shaped oven upper part 2, which are preferably composed of a multitude of segments. As a result of this segment structure the oven can be transported, set up, and dismantled without problem.

To provide for easier maintenance, the oven upper part 2 is preferably designed passable and raisable by means of a spindle lifting means 3. This type of raising permits the oven upper part to be in an absolutely horizontal position also during the raising process and in the raised position. The spindle lifting means 3 is disposed for this purpose on at least two sides of the oven, preferably has four lifting locations at the corners of the oven, and is adapted to the quite considerable weight of the oven upper part.

The oven lower part 1 is supported movable on running rails 15, in order to permit it to be rolled out from underneath the oven upper part. A displacing of the oven upper part would also be possible, of course, to open up the access to the oven interior. As a result of the opening by displacement, it is sufficient if the cover, i.e., the oven upper part, is raised by a few centimeters to permit full access to the oven after the displacement process.

Disposed on the side walls of the oven are multiple viewing windows 4 of heat resisting glass, in such a way that they permit a manual observation of the bending process. The viewing windows may be placed at different heights to enable the operator to have a good view of all regions of the oven interior.

FIG. 2 shows the gravity bending oven in a view from above with a laterally rolled out oven lower part 1. After the oven upper part 2 has been raised by means of the spindle lifting means 3, the oven lower part 1 can be laterally displaced on the runner rails 15. In this manner the entire opening width of the oven lower part 1 is available for loading and unloading of the glass panes to be bent, resulting in a noticeable improvement of the handling during charging and removal.

Also easily identifiable in FIG. 2 are the segment-like structure of the oven upper part 2 and the preferred positioning of the spindle lift drives. Also shown, in the oven lower part 1, are a plurality of floor segments 16 that are disposed on the oven floor 11 in a grid pattern, which, depending on the load situation, can be taken out of [¹] individually, in order to free up floor space for various bending molds. As a result of the fixed grid, the positions of the bending molds are easily reproducible, so that in this respect as well, a high degree of repetition accuracy is ensured for the process parameters. ¹Translator's note: This translation is based on a German sentence that appears to be incomplete or contains an extraneous preposition.

FIG. 3 shows a detail drawing of the gravity bending oven in a longitudinal section. Arranged in the oven are a plurality of heating groups in the tub-shaped oven lower part 1 and in the cover-shaped oven upper part 2. It is preferred that four first heating groups 5, each with a plurality of resistance-heated elements, are used in the oven lower part 1, and seven second heating groups 6, each with a plurality of medium-wave quartz radiators, in the oven upper part. This creates eleven individually controllable heating zones, which, when adjusted appropriately, ensure a very uniform temperature distribution in the oven.

The oven wall 7 has an insulation 8 of a fiber material, whose surface has a coating made of an agent binding the fiber material. The coating that is used is preferably water glass. The coating prevents individual fibers from becoming detached from the insulation, which could otherwise contaminate the glass being processed. The heat insulation 8 is composed of multiple layers. Arranged inside the insulation 8 is a multitude of channels 9. These channels 9 have a heat transport medium flowing through them to carry heat away from the insulation 8. The present embodiment uses air as the heat transport medium. Alternatively, a suitable liquid, such as water or oil, could be used.

The heated glass releases heat during the cooling phase to the insulation 8, through heat radiation or indirectly through heat transmission. In order to be able to control and accelerate the cooling process in a targeted manner, air is suctioned through the channels 9. For this purpose all channels 9 are routed to a common cool-air collection channel 10 and the air is suctioned off by means of a fan. The cool-air collection channel 10 can be connected, for further utilization of the waste heat, to a heat exchanger, for example. A heat transport liquid that might be used alternatively would be pumped through the channels 9 by means of a pump. The continuous channeling of heat away from the insulation 8 results in an even cooling of the entire oven interior. The described cooling process proceeds very gently, since fresh air is not blown directly into the oven interior, as has been customary up to now, but an indirect cooling occurs instead. This creates a static atmosphere in the oven interior. The cooling is very effective and results in a shortening of the cooling time and, hence, of the total retention time in the oven.

The channels 9 are adapted to the given heat transport medium being used. They may be channels that are directly formed into the insulation, or pipes or tubing installed in the insulation.

In a modified embodiment the heat insulation 8 is composed of different layers. The inwardly facing layer has a fairly good heat transfer coefficient, in order to route the thermal energy as quickly as possible to the channels 9 and to the heat transport medium flowing therein. The outwardly facing layers, in contrast, are composed such that they result in the best possible heat insulation. In this manner energy losses can be kept small and the outer wall of the oven maintains a surface temperature which prevents burns during physical contact, despite high inside temperatures.

The oven floor 11, in the illustrated embodiment, furthermore has disposed in it a multitude of incoming-air openings 12 below the first heating groups 5. Arranged in the oven upper part 2 are a plurality of outgoing-air openings 13. Incoming air flows through the incoming-air openings 12 via the heating groups 5 that are arranged on the oven floor 11 and is thus brought to interior oven temperature immediately after entering into the oven chamber. As a result of the targeted routing of the air over the heating elements, it is ensured that cooler air flow does not hit the glass plates in the oven interior. When the incoming-air and outgoing-air openings 12, 13 are open at the same time, a slight air circulation movement is created inside the oven. This air circulation movement provides for an additional evening out of the temperature, for example during the preheating and bending process. For regulating the incoming and outgoing air volume, the incoming-air and outgoing-air openings 12, 13, are adjustable from a fully closed position all the way to a fully open position. The outgoing air that flows off through the individual outgoing-air openings 13 is routed to a common outgoing-air collection channel and suctioned off by means of a fan. The channeled off outgoing air volume can therefore be precisely adjusted via the fan. The outgoing air volume determines the air circulation movement inside the oven, which is therefore ideally adjustable in each phase of the preheating and bending process.

FIG. 4 shows, in a simplified flow diagram, the essential steps of the inventive method for gravity bending of glass panes. The method is preferably carried out in the above-described gravity bending oven.

The process starts in step 20. In step 21, a raising of the oven upper Part takes place by means of a spindle lifting means, followed by a displacement of the oven lower part. In step 22 at least one glass pane is inserted into at least one bending mold located in the oven lower part. The oven is dimensioned such that glass panes having a width up to 3000 mm, a depth up to 6000 mm, and a thickness of approximately 20 mm can be processed. Multiple smaller panes that are placed into multiple bending molds can, of course, be processed as well.

In the subsequent step 23, an even heat penetration and heating of the glass pane to bending temperature takes place by means of a plurality of heating groups in the oven upper part and oven lower part. To support the heating and bending process, a circulating air movement can be created in the oven. For this purpose incoming air enters via a multitude of incoming-air openings in the oven floor into the oven interior, with outgoing air simultaneously being channeled out of the oven interior via a plurality of outgoing-air openings arranged in the oven upper part. These openings are adjustable to regulate the incoming and outgoing air volume. The outgoing air volume can additionally also be adjusted via a fan.

After completion of the shaping process, the first cooling phase of the glass pane follows in step 24. During this cooling process, the heated glass pane initially releases the heat to the insulation. To channel off this heat, a heat transport medium, such as water or air, flows through a multitude of channels disposed in the insulation. An even and relatively rapid cooling of the oven interior takes place until a specified temperature is reached, at which harmful material stresses can no longer occur in the glass pane because a certain hardness has been reached.

The additional cooling can subsequently be accelerated in step 25 through additional inflow of ambient air via the incoming-air openings or also through a slight raising of the oven upper part.

Starting at a certain temperature, the oven can be fully opened to roll out the oven lower part.

The glass pane can then continue to cool off until it can be removed in step 26 without the risk of damage. The process ultimately ends in step 27.

Additional embodiments of the gravity bending oven and adapted process steps are conceivable.

### LIST OF REFERENCE NUMERALS

1 oven lower part
2 oven upper part
3 spindle lifting means
4 viewing window
5 first heating groups
6 second heating groups
7 oven wall
8 insulation
9 channels
10 cool-air collection channel
11 oven floor
12 incoming-air openings
13 outgoing-air openings
14 outgoing-air collection channel
15 running rails
16 floor segments

What is claimed is:

1. A gravity bending oven for glass panes, having a plurality of heating groups (5, 6) in a tub-shaped oven lower part (1) and in a cover-shaped oven upper part (2), and having a heat insulation (8) on the inside of the oven walls (7), characterized in that the heat insulation (8) has arranged in it a multitude of channels (9), which, in order to carry heat away from the heat insulation (8), have a heat transport medium flowing through them.

2. A gravity bending oven according to claim 1, characterized in that the oven interior has a height greater than 800 mm, a width greater than 2000 mm, and a depth greater than 2000 mm.

3. A gravity bending oven according to claim 1 or 2, characterized in that the heat insulation (8) consists of a heat resisting, poorly heat conducting fiber material, and that the surface of the heat insulation facing the oven interior has a coating made of an agent binding the fibers.

4. A gravity bending oven according to any of claims 1 through 3, characterized in that air or a liquid with high heat capacity are used as the heat transport medium.

5. A gravity bending oven according to any of claims 1 through 4, characterized in that the heating groups (5, 6) are controllable independently from each other.

6. A gravity bending oven according to any of claims 1 through 5, characterized in that the oven upper part (2) can be raised by means of a spindle lifting means (3) and that the oven lower part (1) is displaceable in the raised position of the oven upper part (2), in such a way that the entire opening width of the oven lower part (1) is accessible.

7. A gravity bending oven according any of claims 1 through 6, characterized in that medium-wave quartz radiators are used as first heating groups (5) in the oven upper part (2) and resistance heating elements are used as second heating groups (6) in the oven lower part (1), and that the quartz radiators are supported without lateral guiding means.

8. A gravity bending oven according to any of claims 1 through 7, characterized in that on the oven floor (11) above the heat insulation (8) a heating receptacle with load-bearing capacity is arranged in the form of a grid, that the oven floor region above the grid is subdivided into a multitude of removable floor segments (16), and that in place of removed floor segments, bending molds can be arranged on the oven floor.

9. A gravity bending oven according to any of claims 1 through 8, characterized in that a plurality of incoming-air openings (12) in the oven floor (11) are arranged below the heating groups (6) provided there, and a plurality of outgoing-air openings (13) are arranged in the oven upper part (2), and that these openings are adjustable from a fully closed position all the way to a fully open position.

10. A gravity bending oven according to claim 9, characterized in that the outflowing volume of outgoing air is adjustable via a fan.

11. A method for gravity bending of glass panes in a gravity bending oven, whose insides of the oven walls have a heat insulation (8), comprising the following process steps:
Insertion (21) of at least one glass pane into at least one bending mold located in the oven lower-part (1);
even heat penetration and heating (23) of the glass pane to bending temperature by means of a plurality of heating groups (5, 6);
cooling of the glass pane following the shaping process;
characterized in that the gravity bending oven is opened only after a specified solidification temperature has been reached, and that at least until that time the heat released to the heat insulation (8) during the cooling process (24) is channeled off via a heat transport medium that flows through a multitude of channels (9) arranged in the heat insulation (8).

12. A method for gravity bending of glass panes according to claim 11, characterized in that glass panes having a width up to 3000 mm, a depth up to 6000 mm, and a thickness up to 20 mm can be processed.

13. A method for gravity bending of glass panes according to claim 11 or 12, characterized in that for insertion (21) of the glass panes, the oven upper part (2) is raised by means of a spindle lifting means (3) and the oven lower part (1) is subsequently displaced to such a degree that the entire opening width of the oven lower part (1) is available for the insertion process.

14. A method for gravity bending of glass panes according to any of claims 11 through 13, characterized in that during the heating or bending process (23) incoming air is admitted into the oven interior via a multitude of incoming-air openings (12) located in the oven floor (11) below the heating groups (5), and that outgoing air is channeled out of the oven interior via a plurality of outgoing-air openings (13) arranged in the oven upper part (2), said openings (12, 13) being adjustable from a fully closed position all the way to a fully open position.

15. A method for gravity bending of glass panes according to claim 14, characterized in that the outflowing outgoing-air volume is adjusted via a fan.

16. A method according to any of claims 11 through 15, characterized in that it is carried out using a gravity bending oven according to any of claims 1 through 10.
